(19) United States
(12) Patent Application Publication
(10) Pub. No.: US 2014/0299440 A1
(43) Pub. Date: Oct. 9, 2014

(54) SMOOTH ENGAGEMENT ELEMENT FOR CLUTCH FRICTION DEVICE

(71) Applicant: VALEO MATERIAUX DE FRICTION, Limoges (FR)

(72) Inventors: Pierre DUMAS, Burgnac (FR); Philippe PANTIER, Lauriere (FR); Philippe PINEDA, Brive La Gaillarde (FR); Valérie TESSIER, Panazol (FR); Géraud VATIN, Rilhac Rancon (FR)

(73) Assignee: VALEO MATERIAUX DE FRICTION, Limoges (FR)

(21) Appl. No.: 14/251,275

(22) Filed: Apr. 11, 2014

Related U.S. Application Data
(63) Continuation of application No. 11/915,612, filed on Feb. 5, 2008, now abandoned.

(30) Foreign Application Priority Data
Jun. 23, 2005 (FR) 0551745

(51) Int. Cl. F16D 13/64

(52) U.S. Cl. CPC F16D 13/64
USPC 192/107 M

(57) ABSTRACT

A friction device has a center axis (A) and a mid plane (P) perpendicular to the center axis (A). The friction device comprises first and second shields coaxial to the center axis (A) and pieced together to form a radially emerging peripheral slot between internal faces thereof, first and second friction linings fixed to external faces of the first and second shields, first connecting torques made in one piece with the first shield and having a circumferential orientation, second connecting torques made in one piece with the second shield and having a circumferential orientation, and a progressiveness element disposed in the peripheral slot and pressed between the internal faces of the first and second shields. The second connecting torques are inclined with respect to a plane of the second shield towards the mid plane (P) of the friction disc. The progressiveness element at least partly comprises an addition silicone.

### CROSS-REFERENCE TO RELATED APPLICATIONS

This application is a continuation of U.S. Utility patent application Ser. No. 11/915,612 filed on Feb. 5, 2008, which claims priority to International Application No. PCT/FR2006/050613 filed Jun. 20, 2006 and French Patent Application No. 0551745 filed Jun. 23, 2005, which are incorporated herein by reference in their entirety and to which priority is claimed.

### FIELD OF THE INVENTION

The invention concerns a progressiveness element for a clutch friction device, in particular for a motor vehicle, a clutch friction device comprising such a progressiveness element and a method of manufacturing such a friction device.

### BACKGROUND OF THE INVENTION

A motor vehicle clutch makes it possible to selectively connect and disconnect an engine flywheel and a gearbox input shaft. To this end, the clutch comprises conventionally a mechanism, rotationally fixed to the engine flywheel, and a friction device rotationally fixed to the input shaft of the gearbox.

A friction device comprises a metal disc pieced at its centre. First and second linings in the form of flat rings are fixed to the periphery of each of the faces of the disc.

The mechanism comprises a pressure plate and a reaction plate, coaxial with the friction device, facing the first and second linings respectively. It also comprises a diaphragm, also coaxial with the friction device, the actuation of which brings the pressure and reaction plates closer together or further apart between engaged and disengaged positions.

In the engaged position, the plates sufficiently grip the linings to allow a transmission of torque between the mechanism and the friction device.

In the disengaged position, on the other hand, the plates are sufficiently separated for the mechanism and the friction device to be mechanically decoupled and be able to turn independently of each other.

Apart from the selective transmission of torque, a friction device must also provide the progressiveness of this transmission when the vehicle starts up and during gear changes. This progressiveness contributes to driving comfort, limits noise and improves the distribution of forces on the linings and plates.

To this end, the disc can for example be locally deformable in line with the linings.

As described in EP 0 504 033, an elastic cellular material can also be disposed between the linings and the disc in order to ensure the progressiveness of the transmission. The cellular material is formed from materials belonging to the group comprising elastomer foams, such as silicone foams and fluorinated rubber foams, thermoplastic materials moulded with gas blown in in order to create a porosity, such as polyamides, polyether ketones, or thermosetting resin foams having sufficient flexibility such as modified epoxy resins.

EP 0 504 033 also describes a second embodiment in which the disc is formed by assembling first and second shields. Each shield, in the general form of a disc, has a flat central connecting part, an annular flat peripheral part extending radially parallel to the central part, and an intermediate part connecting the central part and the peripheral part while providing an axial offset of the peripheral part with respect to the central part. The central parts of the shields, with a central recess, are contiguous.

The linings are fixed to the external faces of the peripheral parts.

The intermediate parts of the first and second shields are conformed so that, by coaxially fixing together the central parts to form the disc, the peripheral parts are separated axially from each other and form with the intermediate parts a peripheral groove or “slot” opening out radially.

The elastic cellular material at least partially fills the peripheral slot of the disc. This material thus fulfils the progressiveness function without interfering with the fixing of the linings to the disc.

EP 0 419 329 also describes a friction device comprising a disc similar to the disc of the second embodiment of EP 0 504 033. Progressiveness is ensured by means of a plurality of protuberances made from a silicone-based rubber that extend radially in the peripheral slot.

Finally, EP 0 446 098 describes a friction device similar to that of EP 0 419 329 but where the protuberances are produced in the form of loops.

All the “progressiveness elements” used up to now and in the form of a buffer made from an elastic material interposed between the two linings have the drawback of taking a long time to implement. This is because the duration of polymerisation of the materials used generally exceeds ten minutes and may even be as much as a day. These progressiveness elements are therefore unsuited to industrial production at high rate.

There thus exists a need for a novel progressiveness element that can be interposed between the two linings and that is better suited to the methods for the industrial manufacture of friction devices. The aim of the invention is to satisfy this need.

### SUMMARY OF THE INVENTION

According to the invention, this aim is achieved by means of a progressiveness element consisting at least partly, preferably totally, of an addition silicone (or “addition polysiloxane”).

Advantageously, the polymerisation of such a silicone is very rapid.

The preferred addition silicones are the DOW CORNING® 3-6096 silicone elastomer from the company Dow Corning and the ADDISIL 6100 silicone elastomer from GE Bayer Silicones GmbH & Co KG (Germany).

Preferably, the progressiveness element also has one or more of the following characteristics.
The silicone is a single-component silicone. Preferably, the polymerisation results from heating, preferably by means of infrared radiation.
The silicone is a silicone of the polydimethylsiloxane type, containing in particular vinyl groups.
The silicone is an adhesive silicone. Preferably the silicone is sufficiently adhesive to limit the gaping of the linings in service, that is to say their separation from each other during normal use of the friction device. In this case the progressiveness element therefore also fulfils an anti-gaping function preventing the two linings from moving apart from each other in an undesired fashion.
The silicone has a polymerisation temperature of between 130° and 200° C., preferably approximately 150° to 180° C.

The invention also concerns a clutch friction device, in particular for a motor vehicle, comprising a disc and a progressiveness element according to the invention.

Preferably, the friction device also has one or more of the following characteristics.
A progressiveness element according to the invention is disposed, preferably adhesively bonded, between a lining fixed to the disc and the disc. Preferably, a progressiveness element according to the invention is disposed, preferably adhesively bonded, between each of the linings fixed to the disc and the disc.

Preferably again, at least one progressiveness element according to the invention makes a lining adhere to the disc. Its function is therefore dual: fixing the lining to the disc and ensuring progressiveness of the friction device.
A progressiveness element according to the invention is disposed, preferably adhesively bonded, in a radially emerging peripheral slot provided on the disc. Preferably again, this slot is formed by assembling two shields, for example as described in EP 0 419 329 or EP 0 504 033.

Finally, the invention concerns a method of manufacturing a clutch friction device, in particular for a motor vehicle, the friction device comprising first and second shields assembled in a friction disc and providing a radially emerging peripheral slot, and first and second linings fixed to external faces of the first and second shields.

According to the invention, this method comprises the following steps:

A) application of an adhesive to an internal face of the first lining and affixing of the said internal face to the external face of the first shield, and

B) independently of step A), preferably subsequently to step A), application, to a surface of the first shield intended to delimit the peripheral slot, of a composition comprising an addition silicone able to polymerise under the same conditions as the adhesive in order to form a progressiveness element according to the invention, and then fitting of the second shield against the first shield, and

C) after steps A) and B), simultaneous polymerisation of the adhesive and silicone.

Advantageously, the setting of the adhesive and silicone are therefore simultaneously, which simplifies the manufacturing method.

Preferably, the silicone used is a single-component silicone whose polymerisation commences only as a consequence of heating. Unlike traditional silicones used, the polymerisation commences as soon as the clutch friction device is assembled, the silicones according to the invention afford great flexibility in use. It is in particular possible to envisage the intermediate storage of the assembled or partially assembled parts, the silicone not being polymerised, and this as long as the said parts are not raised to the polymerisation initiation temperature.

The silicone can also be chosen to serve as an adhesive for fixing at least one of the linings to the disc. In other words, the adhesive for fixing at least one of the linings is the same material as the silicone forming the progressiveness element.

### BRIEF DESCRIPTION OF THE DRAWINGS

Other characteristics and advantages of the present invention will emerge from a reading of the following description and an examination of the accompanying drawing, in which:

FIG. 1 depicts an exploded view of a friction device according to the invention, according to a first embodiment;

FIGS. 2a to 2e depict views in radial section of a detail of various embodiments of a friction device according to the invention;

FIG. 3 depicts the progressiveness curves for a friction device according to invention at various steps of a load stressing test.

### DESCRIPTION OF THE PREFERRED EMBODIMENTS

In the various figures, identical references are used for designating identical or similar components.

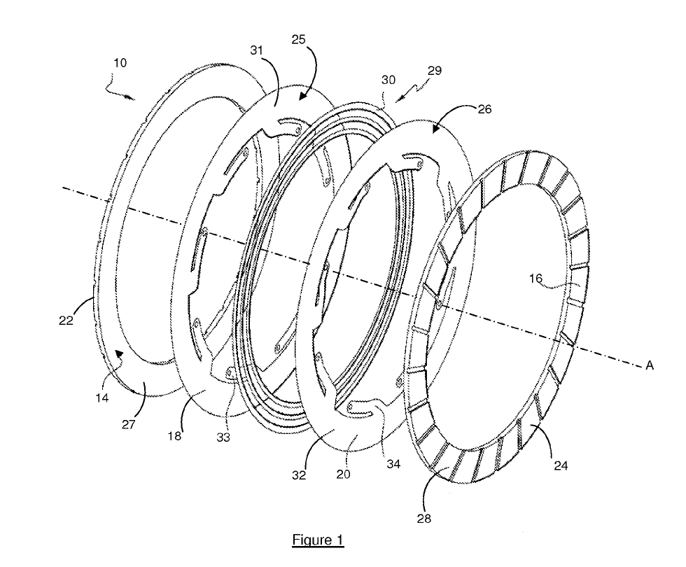

FIG. 1 depicts a friction device 10.

The friction device 10 has a center axis A comprises a metal disc 12, pieced at its centre, thus having the general shape of a flat annulus. First and second linings, 14 and 16 respectively, each in the form of a flat ring coaxial with the center axis A, are fixed to the periphery of the first and second lateral external faces 18 and 20 of the disc 12, respectively.

External faces 22 and 24 of the linings 14 and 16 are intended to cooperate with a pressure plate and a reaction plate (not shown), respectively.

The disc 12 comprises first 25 and second 26 shields (or “shims”), substantially flat and parallel and coaxial with the center axis A, in the form of a pieced disc. The internal faces 27 and 28 of the first 14 and second 16 friction linings are fixed, for example by adhesive bonding or rivets, to the external faces 18 and 20 of the first 25 and second 26 shields, respectively. In a variant, a shield and the corresponding lining can be formed in a single piece, for example by injection molding.

The first 25 and second 26 shields can for example consist of a composite material or steel preferably comprising 0.68% or 0.75% carbon (designated respectively XC68 and XC75 according to the French AFNOR standard). They are substantially annular, coaxial with the center axis A, and separated axially from each other by means of a progressiveness element 29 taking the form of a plurality of concentric beads 30 coaxial with the center axis A and interposed between two continuous, annular internal faces 31 and 32 of the shields 25 and 26.

Preferably, the progressiveness element 29 comprises three beads 30.

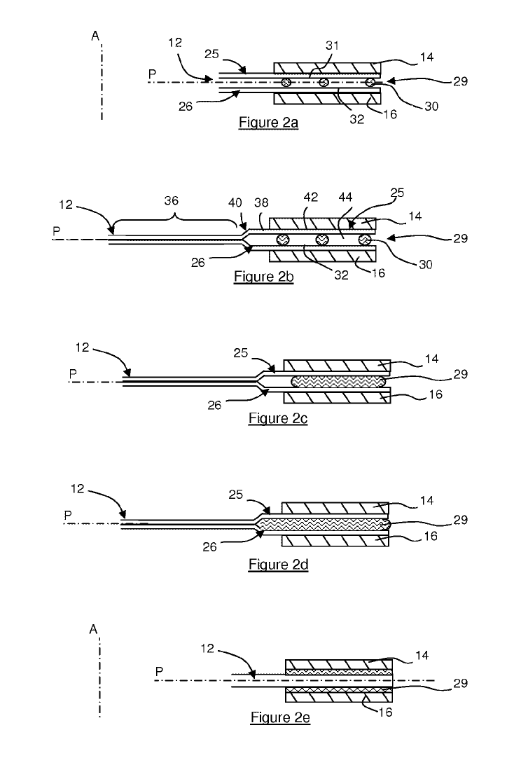

The friction device 10 also comprises first and second connecting torques, 33 and 34 respectively, made in one piece with the first and second shields 25 and 26, respectively. Each of the first and second connecting torques 33 and 34 has a circumferential orientation. The second connecting torques 34 is inclined with respect to the plain of the shields towards a mid plane P of the friction device 10 (shown in FIGS. 2a-2e). As further illustrated in FIGS. 2a and 2e, the mid plane P is substantially perpendicular to the center axis A. The free end of each first connecting torque 33 is conformed and arranged so as to be connected to the surface of a corresponding second torque 34 when the first and second shields move axially with respect to each other, in particular as a consequence of a gripping of the friction device between the pressure plate and the reaction plate. The first and second shields 25 and 26 then move parallel with respect to each other by screwing along their axis A. The optional presence of the connecting torques 33 and 34 advantageously improves the contact of the friction linings with the pressure and reaction plates.

According to the invention, the progressiveness element 29 is, at least partially, an addition silicone. Part of the bead 30, an entire bead 30, or preferably all the beads 30 are made from an addition silicone.

The silicone elastomers are the result of a cross-linking, that is to say an addition or condensation polymerisation that binds the polymer chains to each other. The degree of cross-linking and any reinforcement with mineral fillers determine the final mechanical properties of the elastomer.

There are “condensation silicones” and “addition silicones”.

Condensation silicones are obtained by means of a so called “condensation” reaction during which, in order to form a silicone molecule, two or more molecules are combined, generating a by-product. Typically, such a condensation reaction involves, in addition to the polymers, cross-linking agents and possibly reinforcing fillers, water and a catalyst, for example titanium or tin. The condensation reaction is slow, generally taking several hours, whether the system be single-component or two-component.

Addition silicones result from a so-called “addition” reaction in which a silicone molecule is formed by the juxtaposition of two or more others without the formation of a by-product. Typically, such an addition reaction involves, in addition to the polymers, cross-linking agents and possibly reinforcing fillers, and a catalyst, in particular a noble metal such as for example platinum, rhodium, iridium or palladium. The presence of traces of platinum, in particular around 1 to 20 ppm by weight, in the silicone normally indicates that a silicone is an addition silicone. The addition reaction is rapid, generally taking a few minutes, whether the system be single-component or two-component.

Similar to addition silicones, peroxide cross-linking silicones decompose at high temperature in order to produce highly reactive free radicals that will promote the formation of chemical bonds between the linear chains that constitute the polymer matrix. Peroxides have been used for decades in the field of solid silicones. By-products are formed, with an unpleasant odour, and not always inoffensive. In some cases legal restrictions can be expected.

Addition silicones afford many advantages compared with the peroxide cross-linking ones:
there are no by-products generated (that is to say no risk of toxic products)
there is more rapid polymerisation (up to 50%).

The preferred addition silicones are the DOW CORNING® 3-6096 silicone elastomer, ADDISIL 6100 and RHODORSIL® ESA 7142.

The DOW CORNING® 3-6096 silicone elastomer from the company Dow Corning is a single-component addition silicone in the form of a black paste. It polymerizes under heat, in less than 5 minutes at 180° C.

The Addisil 6100 silicone from GE Bayer Silicones GmbH & Co. KG (Germany) is a polydimethyl siloxane containing vinyl groups with pyrogenic silicic acid. It polymerises in less than 2 minutes at 175° C.

RHODORSIL® ESA 7142 is a single-component silicone elastomer of the polyaddition type, non-flowing and cross-linking hot. Manufactured by the company Rhodia Silicones s.a.s. (France), it is recommended for the sealing and protection of housings by jointing and filling, as well as for the isolation of electric motors. This adhesive is based on polymethyl vinylsiloxanes, polymethyl hydrogenosiloxanes and silica.

Constituents other than an addition silicone can be mixed with the latter in order to form a progressiveness element 29 according to the invention.

FIG. 2a shows a schematic radial section of a peripheral part of the friction device 10 shown in FIG. 1, in a zone where the disc 12 does not have any connecting torque.

Many other embodiments are possible.

For example, FIGS. 2b to 2d show embodiments of the invention in which the first and the second shields 25 and 26 have the general shape of a disc with a central recess, with a flat central part 36, a flat peripheral part 38 extending as substantially radially parallel to the central part 36, and an intermediate part 40 connecting the central part 36 and the peripheral part 38. The linings 14 and 16 are fixed in the external faces 42 of the peripheral parts 38.

As in EP 0 504 033, the intermediate parts 40 of the first and second shields 25 and 26 are conformed so as to shift the peripheral parts 38 axially and outwards with respect to the central parts 36 so as to form a radially emerging peripheral slot 44.

The progressiveness element 29 according to the invention can be formed by beads 30 disposed inside the slot 44 and pressed between the internal faces 31 and 32 of the peripheral parts 38. The progressiveness element 29 according to the invention can also be formed by a single bead partially (FIG. 2c) or completely) FIG. 2d) filling the slot 44.

The FIG. 2e depicts another embodiment in which a progressiveness element 29 is interposed between each lining 14 and 16 and the disc 12. Preferably, the progressiveness element 29 also serves to bond the linings to the disc 12. In this embodiment, the disc 12 is single-piece. The arrangement of the progressiveness element 29 between the linings 14 and/or 16 and the disc 12 is also possible with a disc 12 in two parts 25 and 26, as described above. In this case, a progressiveness element according to the invention can also be inserted in the peripheral slot 44.

The manufacture of the friction device shown in FIGS. 1 and 2 can be carried out in the following manner:

a) The internal faces 27 and 28 of the linings 14 and 16 are first of all glued, and then they are bonded respectively to the external faces 18 and 20 of the shields 25 and 25 previously prepared for this purpose. This preparation, for example cleaning by means of a solvent and/or the application of a primer, depends on the nature of the adhesive and is well known to persons skilled in the art.

b) Next the adhesive is polymerised by heating.

c) Then, according to the recommendations of the manufacturer of the silicone used, the internal faces 31 and 32 of the shields 25 and 26 are cleaned and, if necessary, a primer is applied.

d) Next addition silicone beads 30 are formed on the internal face 31. Preferably, the silicone used is a single-component silicone whose polymerisation commences only as a consequence of heating. After having deposited the silicone on the internal face 31, the shields can therefore be manipulated and transported for as long as necessary. In addition, any risk of undesired polymerisation, for example of traces of silicone on the appliances used for depositing the beads 30, is avoided. The triggering of the polymerisation can advantageously be perfectly controlled. The use of a single-component silicone is thus well suited to the constraints of industrial production of the friction device.

e) The internal faces 31 and 32 of the shields 25 and 26 are brought together, arranging them separated from each other by a defined distance less than the silicone extrusion diameter. The silicone deposited on the internal face 31 is thus also in contact with the internal face 32. Preferably, the shields 25 and 26 are clamped, thus to say they are kept firmly immobilised with respect to each other so that they do not undergo any distortion during the following step.

f) Depending on the silicone, the material of the beads 30 is then heated so that it polymerises by addition. The heating is preferably carried out by conduction or irradiation by means of infrared radiation. Advantageously, the polymerisation of the addition silicones is rapid.

According to a variant of the manufacturing method according to the invention, an adhesive is chosen for fixing the linings and an addition silicone for constituting the progressiveness element that have similar polymerisation conditions. For example, the adhesive can be an adhesive of the Araldyte 64 type, which cross-links at 180° C., and the silicone can be a DOW CORNING® 3-6096 silicone, ADDISIL 6100 from Bayer Silicones or RHODORSIL® from Rhodia Silicones s.a.s. In a particular embodiment, in particular in a friction device of the type shown in FIG. 2e, the silicone can also be chosen to serve as an adhesive for fixing the linings.

It is then possible to proceed in accordance with step a), and then steps c) to f) described above, that is to say without executing polymerisation of the adhesive (step b)) prior to the polymerisation of the silicone. At step f), the heating of the friction device allows simultaneous setting of the adhesive and silicone. The manufacturing method is advantageously simplified and more economical.

An axial load stressing test was carried out in order to evaluate the fatigue strength of the progressiveness element according to the invention. This test consists of applying to a friction device of a clutch, cyclically, an axial force corresponding to the maximum rating of this clutch.

The friction device tested, of the type shown in FIG. 2a, had an outside diameter of 215 mm. It comprised a progressiveness element made from the DOW CORNING® 3-6096. The axial force applied was 7300 N.

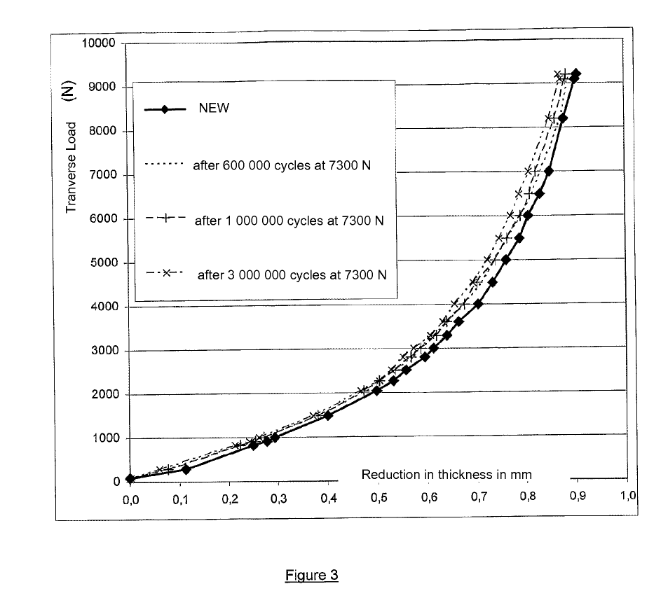

FIG. 3 shows the progressiveness curves of this friction device after 0, 600,000, one million and three million cycles. A progressiveness curve represents the reduction in thickness, in millimetres, of a progressiveness element under the effect of a transverse load.

Very good preservation of the progressiveness curve with the DOW CORNING® 3-6096 addition silicone is found. The conventional friction device whose progressiveness is achieved by the curvature of metallic blades does not offer such good results.

As now appears clearly, the invention provides a progressiveness element that can be interposed between the two linings (between at least one lining and the friction disc and/or inside a peripheral slot of the disc extending in line with the linings) and that is well suited to industrial manufacturing processes for friction devices. The duration of polymerisation of the progressiveness element is in fact advantageously very short.

Naturally the present invention is not limited to the embodiments described and shown provided by way of illustrative and non-limitative examples.

In particular, the form of the disc, the shields, the peripheral slot and the linings, or the nature of the means of fixing the linings, are not limitative.

In addition, the progressiveness element forming a spring is not necessarily bonded to each of the shields between which it is interposed. It may have any shape. In particular, the beads may be of any shape, closed or not, and be continuous or not. The progressiveness element may also have the form of studs.

Finally, the peripheral slot does not necessarily extend over the entire periphery of the disc. Preferably, its depth is however sufficient so that it extends in line with the entire bearing surface of the linings on the disc.

1. A friction device for a clutch of a motor vehicle, the friction device having a center axis (A) and a mid plane (P) perpendicular to the center axis (A), the friction device comprising:
first and second shields coaxial to the center axis (A) and pieced together to form a disc, each of the first and second shields having internal and external faces;
first and second friction linings fixed to the external faces of the first and second shields;
the first and second shields forming a radially emerging peripheral slot in the disc between the internal faces thereof;
first connecting torques made in one piece with the first shield and having a circumferential orientation;
second connecting torques made in one piece with the second shield and having a circumferential orientation, the second connecting torques being inclined with respect to a plane of the second shield towards the mid plane (P) of the friction device; and
a progressiveness element disposed in the radially emerging peripheral slot and pressed between the internal faces of the first and second shields; the progressiveness element at least partly comprising beads of an adhesive single-component addition silicone.

2. The friction device according to claim 1, wherein the addition silicone has a polymerization temperature of between 130° and 200° C.

3. (canceled)

4. The friction device according to claim 1, wherein the silicone comprises vinyl groups.

5. The friction device according to claim 1, wherein the silicone is sufficiently adhesive to limit the gaping of the first and second friction linings in service.

6-12. (canceled)

13. The friction device according to claim 1, wherein the beads are in the form of a plurality of concentric beads of the adhesive single-component addition silicone; the concentric beads are coaxial with the center axis (A).

14. The friction device according to claim 1, wherein the silicone is a silicone of the polydimethyl siloxane type.

15. The friction device according to claim 1, wherein each of the first and second shields is made of a composite material.

16. The friction device according to claim 1, wherein each of the first and second shields is made of a sheet metal comprising between 0.68% to 0.75% carbon.

17. The friction device according to claim 1, wherein a free end of each of the first connecting torques is connected to one of the second connecting torques.

18. The friction device according to claim 1, wherein the beads are in the form of a plurality of concentric beads of the adhesive single-component addition silicone; the concentric beads are coaxial with the center axis (A).
